(19) United States
(12) Patent Application Publication
(10) Pub. No.: US 2014/0272094 A1
(43) Pub. Date: Sep. 18, 2014

(54) TEXTURED VEGETABLE PROTEIN AS A MEAT SUBSTITUTE AND METHOD AND COMPOSITION FOR MAKING SAME

(71) Applicant: Advanced Food Systems, Inc., Somerset, NJ (US)

(72) Inventors: Yongkeun Joh, Princeton, NJ (US); Mark Purpura, Florham Park, NJ (US); Nobue Matsuno, New Brunswick, NJ (US)

(73) Assignee: Advanced Food Systems, Inc., Somerset, NJ (US)

(21) Appl. No.: 14/204,663

(22) Filed: Mar. 11, 2014

Related U.S. Application Data
(60) Provisional application No. 61/777,753, filed on Mar. 12, 2013.

(51) Int. Cl. A23J 3/14; A23L 1/221

(52) U.S. Cl. CPC A23J 3/14; A23L 1/221
USPC 426/650; 426/656

(57) ABSTRACT

A process for preparing pieces of textured vegetable protein (“TVP”) suitable as meat substitutes includes the steps of selecting TVP pieces, preparing a marinade solution, marinating the TVP pieces, and cooking the marinated TVP pieces by themselves or with meat. The cooked TVP pieces may then be dehydrated, frozen, or added to other food as cooked. The marinade solution includes polysaccharides or proteins that infiltrate the pores of the TVP and gelatinize therein during the cooking step, thereby modifying the texture of the TVP pieces. Edible oils may be added to the marinade. A cooked TVP piece prepared by the process has a texture and flavor similar to those of a cooked meat.

### CROSS-REFERENCE TO RELATED APPLICATIONS

The present application claims the benefit of U.S. Provisional Patent Application Ser. No. 61/777,253, filed on Mar. 12, 2013, the disclosure of which is incorporated herein by reference in its entirety.

### FIELD OF INVENTION

The present invention relates to the field of food or edible products, including processes, compositions, and products within that field. More specifically, the present invention relates to the preparation of textured vegetable protein as a meat substitute.

### BACKGROUND OF THE INVENTION

Textured vegetable protein (hereinafter, “TVP”) is often used as a low-cost extender in various meat products or as a meat alternative in vegetarian/vegan products. TVP is a dry product and must be hydrated in water before being added to the final food product. Even when hydrated, TVP does not have a natural meat-like texture or flavor after it is cooked. The cooked product may have a spongy texture, and an unpleasant “beany” flavor, or other “off” flavor.

### SUMMARY OF THE INVENTION

A first embodiment of the present invention includes a process for preparing a product comprising cooked TVP pieces having a meat-like texture and flavor that are suitable as meat substitutes. Such a process includes the following steps: (1) selecting TVP pieces; (2) preparing a marinade solution for marinating the TVP pieces; (3) marinating the TVP pieces in the marinade solution; (4) cooking the marinated TVP pieces; and (5) dehydrating the cooked TVP pieces immediately after the cooking step. In alternatives to Step (5), the cooked TVP pieces may be frozen, without dehydration, for future use, or added immediately to other food after the cooking step. In some such embodiments, the marinade solution includes low-molecular-weight polysaccharides or proteins that infiltrate the pores of the TVP and gelatinize therein during the cooking step, thereby modifying the texture of the TVP pieces.

A second embodiment of the present invention includes a marinade for marinating the TVP pieces before they are cooked. The composition includes ingredients that gel with heat, bind with water, or otherwise modify the texture of the TVP. The ingredients may include one or more of food starches or other polysaccharides, hydrocolloids (e.g., gums), egg white powder, protein concentrates (e.g., those made from soy, wheat, or dairy foods), and other substances that affect the texture or flavor of the cooked TVP pieces, so that the resulting product has a meat-like texture and flavor.

A third embodiment of the present invention includes a cooked TVP piece having a meat-like texture and flavor, having been prepared by the process described above. The cooked TVP piece includes added polysaccharides and/or proteins that have been gelatinized in the pores of the TVP.

### BRIEF DESCRIPTION OF THE FIGURE

For a better understanding of the present invention, reference is made to the following detailed description of the exemplary embodiments considered in conjunction with the accompanying drawing, in which:

FIG. 1 is a schematic block diagram of a process for preparing TVP with a meat-like texture and flavor according to an exemplary embodiment of the present invention.

### DETAILED DESCRIPTION OF THE INVENTION

For the purpose of this disclosure, “meat” includes animal muscle tissue, such as beef, chicken, pork, or turkey. “Meat” further includes “seafood,” which term includes animal organisms native to fresh, salt or brackish water, such as fin fish, shellfish, or crustaceans.

“Textured vegetable protein” is a high-protein, porous food product typically prepared from a paste of defatted vegetable seeds, such as soy, wheat, oats, or oil seeds. Soy TVP and wheat TVP are the most commonly used types.

### I. Process for Preparing TVP with a Meat-Like Texture and Flavor

In one embodiment of the present invention, a marinade system is employed to provide TVP with a more meat-like texture and flavor than has been achieved in the prior art. In the marinade system, a dry composition of food-grade substances is hydrated to make a marinade solution (also referred to herein as a “marinade”). Optionally, edible oils may be added to the marinade. The marinade is then combined with the TVP in an amount such that substantially all of the marinade is absorbed into the TVP, leaving little to no free-standing liquid.

FIG. 1 is a schematic block diagram of a process for preparing TVP having a meat-like texture and flavor according to an exemplary embodiment of the present invention. The illustrated steps include the following: (1) selecting TVP pieces; (2) preparing a marinade solution; (3) marinating the TVP pieces in the marinade solution; (4) cooking the marinated TVP pieces, with or without meat; and (5) dehydrating the cooked TVP pieces immediately after the cooking step. In alternatives to Step (5), the cooked TVP pieces may be frozen, without dehydration, for future use, or added immediately to other food after the cooking step. The aforesaid steps are described in more detail herein. Suitable modifications and variations to the exemplary embodiment will be recognized by those having ordinary skill in the field of food technology.

Step 1: Select TVP Pieces

TVP pieces may be selected according to the type of meat or seafood that is to be simulated. Shape and size of the TVP pieces should be considered, as well as their color.

TVP pieces are available commercially in a number of shapes and sizes. A crumbled TVP (“crumbles”) includes small pieces of TVP, having shapes similar to bits of diced or ground meat. “Shreds” have elongated shapes, and are often used to simulate shredded or pulled meat, such as pulled pork, as well as in crab or seafood products. Flaked TVP and nuggets of TVP are also available, as well as specialty shapes that imitate small shrimp or meat pieces. Wheat TVP is lighter in color than soy TVP, but artificially colored TVP is commercially available. Darker TVP pieces typically are better suited for red meats (such as beef), and lighter-colored TVP pieces typically are more suited for lighter-colored meats (such as pork, chicken, turkey, or seafood). However, wheat TVP is often more suitable than soy TVP for simulating meats that have delicate flavors.

Step 2: Prepare Marinade Solution

In a method of preparing a marinade according to some embodiments of the present invention, the marinade solution is prepared by hydrating a mixture of dry food-grade ingredients, including ingredients that gel with heat, bind with water, or otherwise modify the texture of the TVP. As discussed in more detail elsewhere herein, the dry ingredients may include one or more of food starches or other polysaccharides, hydrocolloids (e.g., gums), egg white powder, protein concentrates or isolates (e.g., those made from soy, wheat, or dairy foods), or other substances named elsewhere herein. Other ingredients may include flavoring agents, flavor maskers (e.g., to mask the “beany” flavor of some TVP), spices, antioxidants, and/or coloring agents. The optimum combination of ingredients will depend on the characteristics of the dry TVP pieces, and desired characteristics of the fully-processed TVP pieces. In an embodiment of the method, the marinade ingredients are hydrated in water at room temperature for a suitable time period (e.g., about 10 minutes) to substantially complete the hydration of the marinade ingredients.

Edible oils may also be added to the marinade to provide a more meat-like texture to the TVP. If oils are to be used, emulsifiers must be provided in the dry ingredients. The role of the emulsifiers is to keep the marinade homogenous and prevent separation of the oils. The oils would then be added to the hydrated ingredients. Suitable oils include, without limitation, soybean, canola, olive, or sesame, and other oils that do not solidify at room temperature (e.g., about 20° C.).

Step 3: Marinate the TVP Pieces

The dry TVP pieces are then soaked in the marinade to hydrate them. In an embodiment of the present invention, the proportion of marinade to TVP is selected such that the entire marinade can be absorbed into the TVP pieces. Water may account for as much as about 65% to about 80% of the total weight of a fully-hydrated TVP. Thus, in some embodiments of the present invention wherein the TVP pieces are to be fully hydrated, the proportion of TVP pieces to marinade in the marinating step would be in the ranges of about 20% to about 35% TVP pieces, and about 65% to about 80% marinade.

It may be noted that dry TVP has a hard and crunchy texture. After hydration, TVP becomes moist and fibrous, with a degree of softness and tenderness that depends on the amount of water absorbed into the TVP pieces. Therefore, in an embodiment of the present invention, the amount of marinade can also be selected to provide the hydrated TVP pieces with a desired softness and tenderness.

The marinating step may be performed by a number of methods, including a static soak, a static soak under vacuum, vacuum tumbling, or other soaking and marinating techniques known in the art of preparing food or other edible products. The marinating step may be performed at suitable temperatures (e.g., room temperature or about 20° C.), and for times sufficient for substantially all of the marinade to be absorbed into the TVP pieces. Exemplary soaking or marinating periods may be in the range of about 15 to 30 minutes, or until substantially all of the marinade is absorbed into the TVP pieces. It may be noted that performing the marinating step under vacuum (e.g., about 20 mm Hg) allows the pores of the TVP to expand, thereby facilitating infiltration of the marinade into the expanded pores.

In a method of static soaking according to some embodiments of the present invention, the hydrated marinade and dry TVP pieces are mixed in a ratio of about 80% marinade to about 20% TVP pieces by weight. The marinade and TVP pieces are mixed to evenly expose the TVP pieces to the marinade, then allowed to soak at room temperature for a time sufficient for the TVP pieces to absorb substantially all of the marinade. During the soaking step, the mixture of marinade and TVP pieces is gently stirred about every 10 minutes to evenly distribute the marinade and promote uniform hydration of the TVP pieces. Other forms of gentle agitation may be used. Exemplary soaking periods are 15 minutes each, before and after stirring, or 30 minutes overall.

In a method of static soaking under vacuum according to some embodiments of the present invention, a mixture of marinade and dry TVP pieces is prepared as in the static soaking method discussed above, then placed in a vacuum tumbler. The tumbler is then sealed, and any air is evacuated to a suitable pressure (e.g., about 20 mm Hg). The marinade and TVP pieces are mixed to evenly expose the pieces to the marinade, and then allowed to soak, with stirring or gentle agitation as in the static soaking method discussed above. The pressure in the tumbler is then restored to about 1 atm, and the hydrated TVP pieces are removed.

In a method of vacuum tumbling according to some embodiments of the present invention, a mixture of marinade and dry TVP pieces is prepared as in the static soaking methods discussed above, then placed in a vacuum tumbler. The tumbler is then sealed and any air is evacuated to a suitable pressure (e.g., about 20 mm Hg). The mixture is then tumbled under vacuum for a suitable time period sufficient for the TVP pieces to absorb substantially all of the marinade (e.g., about 20 minutes). After the tumbling cycle has been completed, the pressure in the tumbler is restored to about 1 atm, and the hydrated TVP pieces are removed.

Step 4: Cook the Marinated TVP Pieces

In some embodiments of the present invention, the marinated TVP pieces are then cooked at temperatures, and for times, sufficient to gelatinize the added starches (or other added polysaccharides) and added proteins, providing a more natural-feeling, less-spongy, cooked-meat texture to the TVP pieces. By selecting the cooking conditions, the texture of the TVP pieces can be made softer or firmer, or a crisp or crunchy surface can be created. Cooking conditions can also be selected to alter the taste of the TVP pieces, as may be understood by those skilled in the art of preparing food and other edible products. These improvements in the texture and flavor of the TVP pieces allow larger amounts of TVP to be used as meat extenders or as a meat-like addition to meals, or to create better vegetarian/vegan products.

Suitable methods for cooking the marinated TVP pieces include boiling, steaming, frying, or cooking in a convection or conventional oven. Steaming or boiling the marinated TVP pieces may heat them to a maximum internal temperature of 100° C., although higher temperatures may be achieved under higher pressures. These cooking methods tend to produce soft TVP pieces. Frying, including deep-frying, can provide higher internal temperatures, resulting in firmer texture. Oven-cooking can also provide the TVP pieces with higher internal temperatures, and can be used to provide the TVP pieces with crunchy exteriors. In some embodiments of the present invention, TVP pieces with satisfying meat-like textures can be produced by cooking the marinated TVP pieces to an internal temperature of about 165° F. (i.e., about 75° C.) for a period of about 8-12 minutes.

Step 5: Dehydrate the Cooked TVP Pieces

In some embodiments of the present invention, the cooked TVP pieces are dehydrated for storage or for use in snacks, soup mixes, risottos, or similar quick-cooking foods. The thermal-gelling and water-binding components added to the TVP by the marinade, and then gelatinized by cooking, are believed to greatly facilitate rehydration of the dehydrated TVP pieces when they are immersed in hot water.

Suitable dehydration techniques include oven drying, freeze drying, puff drying, radiant energy vacuum drying, or other drying techniques known in the art of preparing food or other edible products. Optimum drying conditions and final moisture contents and water activities may vary for each type and size of cooked TVP piece to be dried, and for the amount of water remaining in the TVP piece after the cooking step.

In an alternative step to dehydrating the cooked TVP pieces, the TVP pieces may be frozen for storage, then reheated or cooked further for use in preparing a meal. In another alternative step to dehydrating the cooked TVP pieces, the cooked TVP pieces may be added directly to a meal immediately after the cooking step.

### II. Marinade Composition

According to some embodiments of the present invention, a marinade is prepared by hydrating a mixture of dry ingredients, including low-molecular-weight water-soluble hydrophilic ingredients that gel with heat, bind with water, or otherwise modify the texture of the TVP. Such ingredients include, without limitation, food starches or other polysaccharides, food-grade modified cellulose, egg white powder, and protein concentrates or isolate powders (e.g., those made from soy, wheat, or dairy foods). In an embodiment of the present invention, at least some of such ingredients have a sufficiently low molecular weight or a sufficiently small size that they will readily infiltrate the pores of the TVP. Other ingredients in the mixture may include natural or artificial flavors, flavor maskers (e.g., to mask the “beany” or “off” flavor of some TVP), ground spices or spice extracts, antioxidants, and/or natural or artificial coloring agents. The optimum combination of ingredients will depend on the characteristics of the dry TVP pieces, and desired characteristics of the fully-processed TVP pieces, which can include the flavor of the meat intended for the final product.

During the soaking process, the hydrated ingredients in the marinade enter the pores of the TVP as the marinade is absorbed. Cooking the marinated TVP pieces gelatinizes the polysaccharides and/or proteins, reinforcing the structure of the TVP, and further modifying the texture of the TVP pieces. The proteins also modify the texture and flavor of the TVP pieces.

Ingredients of a marinade according to the present invention will typically include food-grade starches. Suitable starches include modified or native food starches, such as those prepared from tapioca, corn, rice, potato, wheat, or other starchy foods, whether the food starch is of a cook-up or instant type. The marinade may also include other food-grade polysaccharides to modify the properties of the TVP pieces, or the physical characteristics of the marinade (e.g., its viscosity). Suitable food-grade polysaccharides include, without limitation, methyl cellulose or other modified cellulose, carrageenan, xanthan gum, guar gum, or locust bean gum. Maltodextrin may also be included. Suitable protein sources include, without limitation, egg white powder, hydrolyzed vegetable protein, protein concentrate powders, and protein isolate powders. Ingredients that may impart flavor to the TVP pieces include, without limitation, dextrose, fructose, sodium chloride, potassium chloride, ground spices or spice extracts, or other natural or artificial flavoring agents. Flavor maskers may also be used. Antioxidants may include, without limitation, citric acid, ascorbic acid, spice extracts, or tocopherol. Other ingredients may be included in the marinade, such as sodium and potassium phosphates, calcium salts or other sources of calcium, vitamins and/or minerals, and natural or artificial coloring agents. If an edible oil is to be included in the marinade, the dry mixture should also include emulsifiers, such as, without limitation, lecithin, mono- and diglycerides, and propylene glycol alginate. While edible oils may be included in the marinade, by their nature, they would not be part of the dry mixture of marinade ingredients.

An example of a marinade for marinating TVP pieces according to the present invention includes:

Marinade Solution

| Ingredients | Weight (g) | Range (g) |
|---|---|---|
| Water (70° F.) | 71.00 | 60-80 |
| Modified Starch | 3.00 | 0.50-5.00 |
| Dextrose | 0.80 | 0.50-3.00 |
| Maltodextrin | 0.90 | 0.50-2.00 |
| Salt | 1.00 | 0.25-1.50 |
| Flavors | 0.45 | 0.05-0.75 |
| Hydrolyzed Vegetable Protein | 0.30 | 0.25-1.00 |
| Seasoning/Spices | 0.25 | 0.15-2.00 |
| Carrageenan | 0.10 | 0.05-0.50 |
| Sodium Citrate | 0.15 | 0.05-0.50 |
| Xanthan Gum | 0.05 | 0.02-0.20 |
| Total | 78.00 | |

In an embodiment of the present invention, marinade and TVP pieces would be combined as follows:

Marinade Solution TVP Mixture

| Ingredients | Percent | Range |
|---|---|---|
| Dried TVP crumbles | 22.00 | 20-40% |
| (Response 4370 ™, Solae LLC) | | |
| Marinade Solution | 78.00 | 80-60% |
| Total | 100.00 | 100.00 |

### III. TVP Pieces with a Meat-Like Texture and Flavor

Certain cooked TVP pieces prepared by an exemplary process according to the present invention have meat-like textures, colors, and/or flavors. They have gelatinized polysaccharides (e.g., starch), and/or gelatinized protein, in the pores of the TVP. Further, they may have various amounts of added flavoring agents, flavor maskers, antioxidants, salts, and natural or artificial coloring agents. Some cooked TVP pieces may also include edible oils such as seed oils or olive oil, and emulsifiers. The cooked TVP pieces may also have different textures on the inside and the outside of a single piece. For example, a cooked TVP may have a soft interior and a crunchy exterior.

Because all of the marinade used to prepare the TVP pieces for cooking is absorbed into the TVP pieces during the marinating step, the amounts of the substances added to the TVP pieces may be estimated by calculating the amount of the substances present in the marinade. Percentages of the added materials by weight, may be calculated on the basis of the total weight of the cooked TVP pieces or the total weight of the cooked TVP pieces minus the weight of the added ingredients. The presence of gelatinized polysaccharides and/or proteins in the pores of the TVP can be determined by microscopic examination of the cooked TVP.

In one embodiment, the cooked TVP pieces prior to dehydration contain gelatinized polysaccharides and/or proteins in an amount within the range of from about 2.5 weight % to about 5.5 weight %. In another embodiment, the cooked TVP pieces prior to dehydration contain gelatinized polysaccharides and/or proteins in an amount within the range of from about 2.5 weight % to about 4.5 weight %. In further embodiments, different amounts of gelatinized polysaccharides and/or proteins (e.g., as indicated elsewhere in this application) may be contained in the cooked TVP pieces.

### IV. Example According to the Present Invention

According to an embodiment of the present invention, cooked TVP pieces were prepared as follows:

(1) A marinade of the following composition was prepared:

Marinade Solution

| Ingredients | Weight (g) |
|---|---|
| Water (70° F.) | 71.00 |
| Modified Starch | 3.00 |
| Dextrose | 0.80 |
| Maltodextrin | 0.90 |
| Salt | 1.00 |
| Flavors | 0.45 |
| Hydrolyzed Vegetable Protein | 0.30 |
| Seasoning/Spices | 0.25 |
| Carrageenan | 0.10 |
| Sodium Citrate | 0.15 |
| Xanthan Gum | 0.05 |
| Total | 78.00 |

(2) The marinade and dried TVP crumbles were added to a soaking vessel in the following proportions:

Marinade Solution TVP Mixture

| Ingredients | Percent |
|---|---|
| Dried TVP crumbles (Response | 22.00 |
| 4370) | |
| Marinade Solution | 78.00 |
| Total | 100.00 |

(3) The dried TVP crumbles were soaked in the marinade for 30 minutes, with gentle stirring every 10 minutes to ensure even distribution of the marinade and even hydration of the marinade by the TVP crumbles.

(4) The hydrated TVP crumbles were cooked to a temperature of 165° F. using steam at 212° F. for 8-12 minutes at a low ventilation rate.

The compositions of the TVP crumbles before and after cooking were as follows:

Composition

| | Before Cook | After Cook |
|---|---|---|
| Ingredients | Percent (%) | Percent (%) |
| Water (70° F.) | 71.00 | 74.46 |
| TVP (Response 4370) | 22.00 | 21.24 |
| Modified Starch | 3.00 | 2.90 |
| Dextrose | 0.80 | 0.77 |
| Maltodextrin | 0.90 | 0.87 |
| Salt | 1.00 | 0.97 |
| Flavors | 0.45 | 0.43 |
| Hydrolyzed Vegetable Protein | 0.30 | 0.29 |
| Seasoning/Spices | 0.25 | 0.24 |
| Carrageenan | 0.10 | 0.10 |
| Sodium Citrate | 0.15 | 0.14 |
| Xanthan Gum | 0.05 | 0.05 |
| Total | 100.00 | 100.00 |

In separate examples, the soaked TVP crumbles prepared under the method described above were mixed with meat prior to cooking, and then steamed under the conditions described above. Control samples of meat only were also cooked by steaming. It may be noted that the symbol “½” indicates that the meat was ground through plates having ½-inch openings. The following results were obtained:

### Example 1

| (5) Ingredient | Control | With TVP |
|---|---|---|
| Ground Pork, ½″ | 44.00 | 27.00 |
| Ground Chicken, ½″ | 13.00 | 13.00 |
| Marinated TVP | — | 17.00 |
| Total | 57.00 | 57.00 |

(Reduction in lean meat (i.e., pork + chicken) = 29.82%

### Example 2

| Ingredient | Control | With TVP |
|---|---|---|
| Ground Pork, ½″ | 16.00 | 3.50 |
| Ground Pork Fat, ½″ | 10.00 | 12.00 |
| Ground Chicken, ½″ | 2.00 | 4.00 |
| Marinated TVP | — | 20.00 |
| Total | 28.00 | 31.50 |

(Reduction in lean meat (i.e., pork + chicken) = 58.33%

The TVP replaced a significant amount of real meat in each of the examples, but the resulting meat/TVP product had the flavor and texture of the control samples. The cost of the meat/TVP product was estimated to be substantially lower than the cost of the product made with meat alone.

It should be understood that the embodiments of the invention described herein are merely exemplary and that a person skilled in the art may make many variations and modifications without departing from the spirit and scope of the invention. All such variations and modifications are intended to be included within the scope of the invention. Exemplary embodiments of the present invention are further defined in the appended provisional claims.

We claim:

1. A method of preparing a piece of textured vegetable protein having pores therein, comprising the steps of:
preparing a marinade solution having at least one substance that gelatinizes upon heating;
marinating a piece of texturized vegetable protein in the marinade solution such that the marinating solution hydrates the textured vegetable protein and the at least one substance infiltrates at least some of the pores of the textured vegetable protein; and
cooking the marinated piece of texturized vegetable protein, thereby gelatinizing the at least one substance, wherein the composition of the marinade solution is such that said method provides the piece of textured vegetable protein with a texture and flavor similar to the texture and flavor of a piece of cooked meat or seafood.

2. The method of claim 1, wherein said method further includes the step of dehydrating the cooked piece of texturized vegetable protein.

3. The method of claim 1, wherein the at least one substance is selected from the group consisting of a starch, a gum, a modified cellulose, a protein concentrate, a protein isolate, and an egg white powder.

4. The method of claim 1, wherein the marinade solution further includes an edible oil and an emulsifier.

5. The method of claim 1, wherein the marinade solution further includes a substance selected from the group consisting of a flavoring agent, a flavor masker, an antioxidant, a salt, a vitamin, a mineral, and a coloring agent.

6. The method of claim 1, wherein the marinating step includes the step of adding the piece of textured vegetable protein to an amount of the marinade solution that can be absorbed entirely into the piece of textured vegetable protein, and said marinating step is performed until substantially all of the amount of marinade solution is absorbed by the piece of textured vegetable protein.

7. The method of claim 6, wherein the amount of the marinade solution is selected to impart a softness to the piece of textured vegetable protein that is similar to the softness of a piece of cooked meat.

8. A dry composition for use in preparing a marinade solution, said composition comprising at least one substance that infiltrates at least some of the pores of a piece of textured vegetable protein when carried by a marinating solution, and gelatinizes within the pores upon being heated.

9. The composition of claim 8, wherein said at least one substance is water-soluble.

10. The composition of claim 8, wherein said at least one substance forms a colloid in water, said colloid having particles of the substance that are small enough to infiltrate the pores of the textured vegetable protein.

11. The composition of claim 8, wherein said at least one substance includes a polysaccharide.

12. The composition of claim 8, wherein said at least one substance is selected from the group consisting of a starch, a gum, a modified cellulose, a protein concentrate, a protein isolate, and an egg white powder.

13. The composition of claim 8, further comprising a substance selected from the group consisting of a flavoring agent, a flavor masker, an antioxidant, a salt, a vitamin, a mineral, and a coloring agent.

14. The composition of claim 8, wherein said composition is formulated to modify the texture and flavor of the piece of vegetable protein upon cooking, thereby providing the piece of vegetable protein with a texture and flavor similar to those of a cooked meat.

15. An edible product, comprising a cooked piece of textured vegetable protein, said piece of textured vegetable protein including at least one substance gelatinized within at least some of the pores of the textured vegetable protein.

16. The edible product of claim 15, wherein said at least one gelatinized substance includes one or both of a polysaccharide and a protein.

17. The edible product of claim 15, wherein said at least one gelatinized substance is selected from the group consisting of a starch, a gum, a modified cellulose, a protein concentrate, a protein isolate, and an egg white powder.

18. The edible product of claim 15, wherein said cooked piece of textured vegetable protein further comprises an edible oil.

19. The edible product of claim 15, wherein said cooked piece of textured vegetable protein has a texture and flavor similar to those of cooked meat.

20. The edible product of claim 15, wherein said cooked piece of textured vegetable protein is in a dehydrated state.
